(19) United States
(12) Patent Application Publication
(10) Pub. No.: US 2026/0340917 A1
(43) Pub. Date: Oct. 29, 2026

(54) SYSTEM AND METHOD FOR GENERATING ADAPTIVE ON-DEMAND 3D ANIMATIONS FOR CONTEXT-AWARE MECHANICAL ASSEMBLY

(71) Applicant: Purdue Research Foundation, West Lafayette, IN (US)

(72) Inventors: Karthik Ramani, West Lafayette, IN (US); Mayank Harendra Patel, West Lafayette, IN (US)

(21) Appl. No.: 19/656,482

(22) Filed: Apr. 23, 2026

Related U.S. Application Data
(60) Provisional application No. 63/793,162, filed on Apr. 23, 2025.

(51) Int. Cl. G06T 13/20; G06F 16/334; G06F 16/35; G06F 40/40; G06V 20/60

(52) U.S. Cl. CPC G06T 13/20; G06F 16/3344; G06F 16/35; G06F 40/40; G06V 20/60

(57) ABSTRACT

A method for providing mechanical assembly guidance to a user comprises receiving a natural language query from the user. The natural language query includes a question relating to at least one part from a plurality of parts of an apparatus that is to be assembled from the plurality of parts. The method further comprises determining a sequence of assembly steps for assembling the apparatus based on the natural language query. The method further comprises determining, for each respective assembly step in the sequence of assembly steps, (i) respective natural language text instructions for the user to perform the respective assembly step and (ii) a respective animation that demonstrates the respective assembly step. The method further comprises outputting, with at least one output device, the respective natural language text instructions and the respective animation for at least one assembly step of the sequence of assembly steps.

This application claims the benefit of priority of U.S. provisional application Ser. No. 63/793,162, filed on Apr. 23, 2025 the disclosure of which is herein incorporated by reference in its entirety.

### FIELD

The devices and methods disclosed in this document relate to mechanical assembly tasks and, more particularly, to providing adaptive on-demand 3D animations for context-aware mechanical assembly.

### BACKGROUND

Unless otherwise indicated herein, the materials described in this section are not admitted to be the prior art by inclusion in this section.

Assembly animations embedded with digital training platforms have become powerful tools for teaching and executing mechanical assembly and disassembly tasks across domains such as education, industrial training, and DIY repair. Assembly animations are effective at step-by-step guidance, visualization of intricate mechanical relationships, and assembly sequences in a clear and engaging manner. Studies have shown that interactive instructional systems significantly enhance user engagement, reduce task completion times, improve comprehension, and lower error rates compared to traditional static resources such as manuals or pre-recorded videos. The animation modality is especially effective for communicating complex spatial procedures that are difficult to understand through text or static images alone.

Despite the benefits of interactive assembly animations, most existing animation systems are rigid and non-adaptive, following a single, predefined animation sequence that does not account for the user's progress, contextual factors such as task variations, or specific instructional needs. They fail to adapt to different users, partial assembly states, or alternate procedural paths that may emerge during real-time interaction. This lack of flexibility becomes particularly problematic in practical scenarios where users might skip steps, remove parts out of order, or seek guidance for individual components. These systems offer limited interactivity as users cannot ask questions such as “Where does this go?” or “Can I skip this part?”, thereby limiting the potential for personalized support.

One major reason for the lack of personalized support is the substantial effort required to create animations. Existing authoring methodologies, such as key-frame animation, procedural systems, or motion capture setups, are time-intensive, require specialized technical skills, and often result in content that is hard to reuse or adapt. These constraints pose significant challenges for supporting real-time, user-driven instruction. Manually producing animations that account for every possible user scenario is infeasible at scale, regardless of the authoring method employed. As a result, most systems default to generic one-size-fits-all style animation sequences that cannot accommodate the diversity of users or the dynamic, non-linear nature of real-world assembly tasks.

### SUMMARY

A method for providing mechanical assembly guidance to a user is described herein. The method comprises receiving a natural language query from the user. The natural language query includes a question relating to at least one part from a plurality of parts of an apparatus that is to be assembled from the plurality of parts. The method further comprises determining a sequence of assembly steps for assembling the apparatus based on the natural language query. The method further comprises determining, for each respective assembly step in the sequence of assembly steps, (i) respective natural language text instructions for the user to perform the respective assembly step and (ii) a respective animation that demonstrates the respective assembly step. The method further comprises outputting, with at least one output device, the respective natural language text instructions and the respective animation for at least one assembly step of the sequence of assembly steps.

### BRIEF DESCRIPTION OF THE DRAWINGS

The foregoing aspects and other features of the system and method are explained in the following description, taken in connection with the accompanying drawings.

FIGS. 1A-1B summarize a workflow for providing mechanical assembly guidance to a user.

FIG. 1C shows an exemplary user interface that enables users to explore assemblies through natural queries and system feedback.

FIG. 2 shows multiple valid assembly sequences for a toy car.

FIG. 3 shows an exemplary embodiment of a mechanical assembly guidance system.

FIG. 4 shows a logical flow diagram for a method for providing mechanical assembly guidance to a user.

FIG. 5A shows pseudocode for a dependency extraction algorithm.

FIG. 5B shows visualizations of the toy car assembly mesh generated by the graphics engine.

FIG. 5C shows visualizations of part meshes and signed distance fields for collision detection and disassembly path planning.

FIG. 5D shows a visual representation of an extracted part dependency graph.

FIG. 6A shows a detailed workflow of the query analysis module for classifying the query type of a natural language query received from the user.

FIG. 6B shows a detailed workflow of the sequence generator for dynamically determining a sequence of assembly steps for assembling the mechanical apparatus.

FIG. 6C shows a detailed workflow of the narration generator for dynamically generating natural language text instructions for the user to perform each assembly step.

FIG. 6D shows a detailed workflow of the animation engine for dynamically generating animations that demonstrate each assembly step.

FIG. 7 shows pseudocode for a camera placement algorithm.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

Despite the increasing availability of interactive 3D instructional systems, users still face significant barriers when learning or executing mechanical assembly tasks. Traditional systems, whether paper-based manuals, pre-recorded videos, or pre-authored 3D animations, are often rigid and non-interactive. These traditional tools don't account for what users already know, what they're currently doing, or what they want to understand. Particularly, users cannot ask questions, explore at their own pace, or receive help tailored to their current state or expertise level. As a result, learners, particularly novices, struggle to understand the spatial and mechanical relationships between parts, leading to confusion, longer completion times, and increased errors. Many users struggle to learn mechanical assemblies using static manuals or rigid animations that can't adapt to their needs.

Even modern 3D systems that support interactivity typically rely on manually authored animations, which are time-consuming to create and difficult to modify once authored. For users, this means the animations cannot adapt to different contexts, such as a partially completed assembly, an incorrectly placed part, or a skipped step. In scenarios where users attempt to deviate from the pre-defined flow or request explanations mid-task, these systems offer little to no support.

Users also face challenges with accessibility and personalization. Instructional content is often designed for a generic audience, ignoring differences in prior experience, learning pace, or terminology familiarity. For instance, a novice may need slower animations and simpler language, while an expert might prefer concise, technical guidance. Yet most systems lack mechanisms to adjust the presentation dynamically.

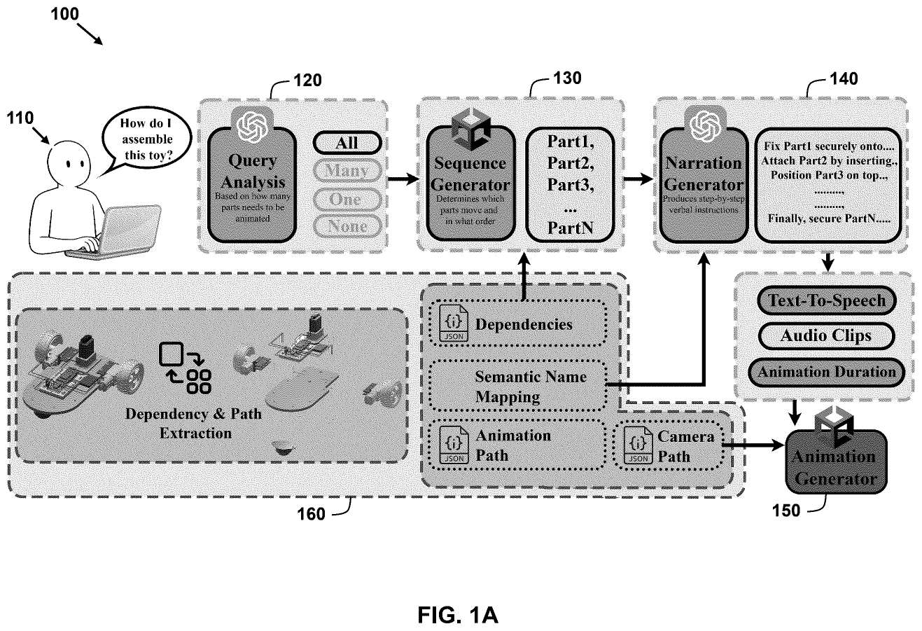

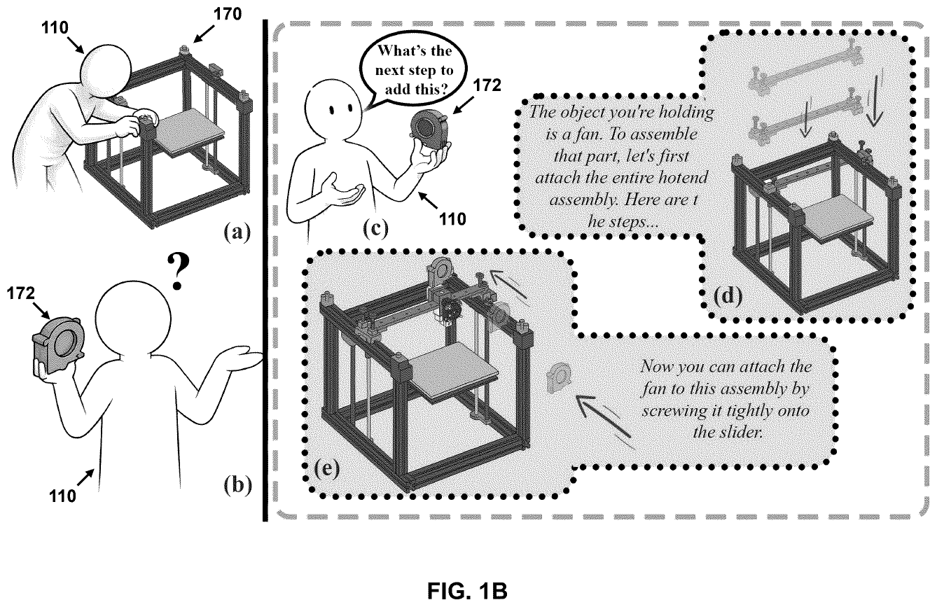

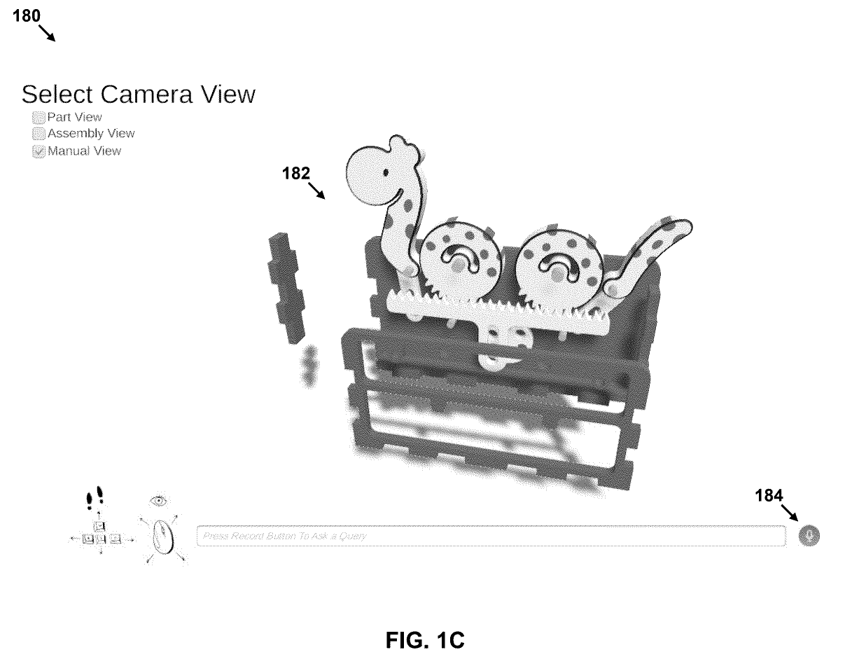

FIGS. 1A-1B summarize a workflow 100 for providing mechanical assembly guidance to a user. The workflow 100 advantageously addresses the above-mentioned challenges by generating real-time, personalized animations and verbal instructions based on user questions and interactions. Particularly, as users explore the assembly of a mechanical apparatus, the system listens to their queries, keeps track of which parts they've removed or inspected, and responds with animations and narration that match the current state of the assembly. This approach helps users get targeted guidance whenever they need it, at their own pace.

The workflow 100 is an end-to-end interaction pipeline that starts with a user query and provides real-time assembly animations and narration. The workflow 100 automatically generates mechanical assembly animations and explanations in response to natural-language user queries. Unlike traditional pre-authored solutions, the workflow 100 dynamically adapts its animations and verbal explanations based on the current instructional context and user interaction history. At its core, the workflow 100 integrates an Assembly-by-Disassembly (ABD) algorithm that analyzes part dependencies by simulating the disassembly process to generate flexible, context-aware animation sequences, rather than relying on a single fixed sequence. The workflow 100 also includes a conversational AI module that interprets user queries and delivers explanations or animations on demand in response to user queries. Together, these components enable users to explore assemblies interactively, receive personalized guidance, and follow instructional flows tailored to their needs-all without relying on pre-authored content.

With reference to FIG. 1A, the workflow 100 is built around several core modules that work together to generate real-time, personalized assembly animations. Each module plays a specific role in delivering adaptive instruction. Firstly, the session begins with a short background questionnaire, where the user 110 provides information such as his or her experience with mechanical assemblies. This helps the system adjust the level of detail and pacing of instructions to match the skill level of the user 110. Next, the user 110 can freely explore a 3D visualization of a mechanical apparatus to be assembled and ask questions using speech, such as “How do I assemble this toy?” or “Where does this part go?” or “How do I reassemble the base?” Next, a query analysis module 120 transcribes the user's query and categorizes it into one of several query types (e.g., full assembly, single part, explanation only), determining whether an animation, narration, or both are required. Next, a sequence generator 130 computes a part-by-part animation sequence based on the current assembly state and query type. The sequence generator 130 adjusts this sequence if the user has previously removed or manipulated parts, ensuring that responses stay aligned with the current context. Next, for each step in the sequence, a narration generator 140 generates verbal explanations tailored to the user's background. Beginners receive more descriptive guidance, while experienced users get faster and more concise responses. The narration explains the role of each part and describes its motion clearly and intuitively. Finally, an animation engine 150 generates and plays synchronized animations and narration. In the animations, the parts of the apparatus to be assembled move along realistic motion paths while the camera automatically adjusts to highlight key actions. The step-by-step narration is converted into audio clips for playback alongside corresponding animations of each step in a synchronized manner. Users can switch to manual camera control at any time, pause playback, or ask follow-up questions to continue exploring.

Prior to the session, a pre-processing module 160 performs dependency and path extraction based on a 3D model of the mechanical apparatus to be assembled, to derive dependencies between parts, as well as motion paths for each part for animating assembly steps. Additionally, the pre-processing module 160 performs semantic name mapping to derive user-friendly, natural-language names for each part in the mechanical apparatus to be assembled. Finally, the pre-processing module 160 derives suitable camera paths to be used for animating assembly steps. These pre-computed dependencies, motion paths, camera paths, and semantic name mappings advantageously enable the workflow 100 to adapt continuously and in real-time to the user's questions and to the current state of assembly of the mechanical apparatus.

With reference to FIG. 1B, an exemplary user experience is illustrated. In illustration (a), the user 110 is working on assembling a 3D printer 170. In illustration (b), the user 110 is unsure about where the part 172 fits and what needs to be assembled before installing the part 172. In illustration (c), the user 110 asks, “What's the next step to add this?” In illustration (d), based on the current assembly state, the system animates the required parts with corresponding audio narration to prepare for the queried part 172. Finally, in illustration (e), the system shows how to attach the part 172 the user was holding, completing the interaction.

FIG. 1C shows an exemplary user interface 180 that enables users to explore assemblies through natural queries and system feedback. The exemplary user interface 180 enables the user to view a virtual model of a mechanical apparatus 182 that is to be assembled. The user interface 180 is primarily query-driven, with most interactions initiated through user input rather than predefined UI controls. Particularly, users can press the microphone button 184 to record natural language queries. Users can interact with the mechanical apparatus 182 by issuing natural language queries to describe actions or request explanations. Users can also directly click on individual parts to select and refer to them in their queries. Additionally, users can freely rotate, zoom, and inspect the mechanical apparatus 182, for example, by pressing the arrow keys on a keyboard or clicking and dragging with a mouse pointer, as well as choose from multiple camera views (part view, assembly view, and manual view). The user interface 180 supports common assembly-view interactions such as replaying and scrubbing animations, and highlighting relevant parts during playback, all of which can be triggered or guided through natural language queries. Based on the interpreted query, the system generates the corresponding animations and instructional narrations, enabling a wide range of assembly-related actions through language while retaining familiar controls for visualization and review.

It should be appreciated that the workflow 100 enables a variety of advantages compared to conventional approaches for assembly guidance. Particularly, the workflow 100 advantageously enables users to request explanations or animations at any time using natural language. This supports self-paced learning and empowers users to explore tasks non-linearly, without being locked into a fixed instructional flow.

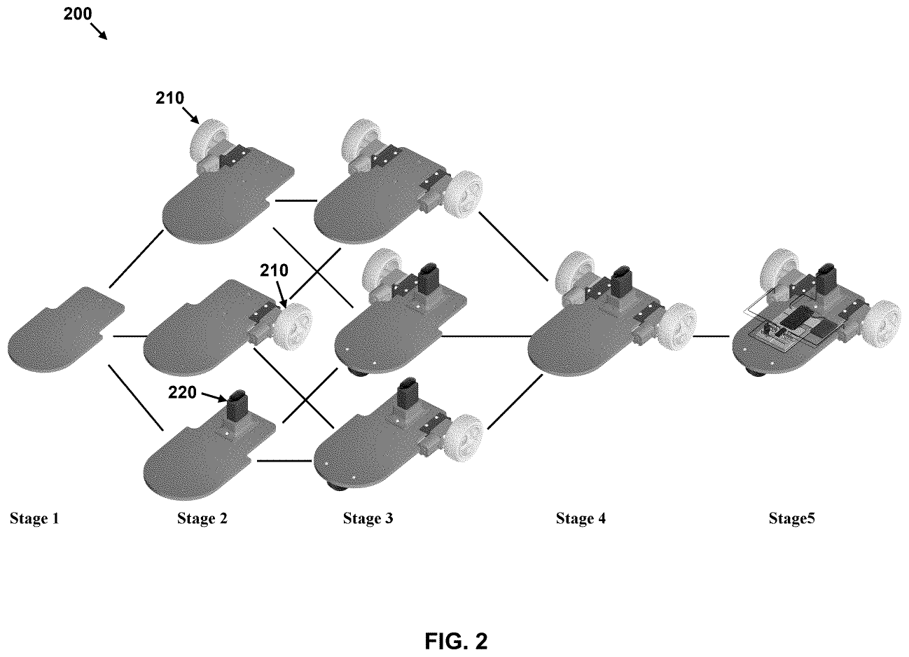

Additionally, the workflow 100 advantageously enables context-aware and adaptive responses. Users often deviate from ideal workflows or have ambiguous questions. The system tracks the current assembly state, detects removed or misplaced parts, and interprets context-dependent queries (e.g., “Where does this go?”), adjusting its responses accordingly. This adaptation is essential because most mechanical assembly tasks can be completed with several different valid sequences of steps. FIG. 2 shows multiple valid assembly sequences 200 for a toy car. As can be seen, even a simple toy car assembly has no single correct sequence. Independent subassemblies, such as the wheel modules 210 and the motor mount 220, can be added in any order without violating physical constraints, yielding multiple valid paths through the assembly. A system locked to one linearization will unnecessarily flag valid user behavior as errors or fail to provide meaningful guidance when users deviate.

Additionally, the workflow 100 advantageously provides personalized and accessible instruction. Users come with varying expertise and familiarity. The workflow 100 adapts its narration pacing, language complexity, and explanation detail based on user profiles, providing novice-friendly guidance and expert-oriented brevity when appropriate.

Finally, the workflow 100 advantageously provides superior assembly animation clarity. For users to grasp mechanical dependencies, the workflow 100 generates animations that respect part constraints, avoid visual collisions, and present actions from appropriate viewpoints. The animations are both physically plausible and visually coherent, without requiring pre-authored content.

### Exemplary Hardware Embodiment

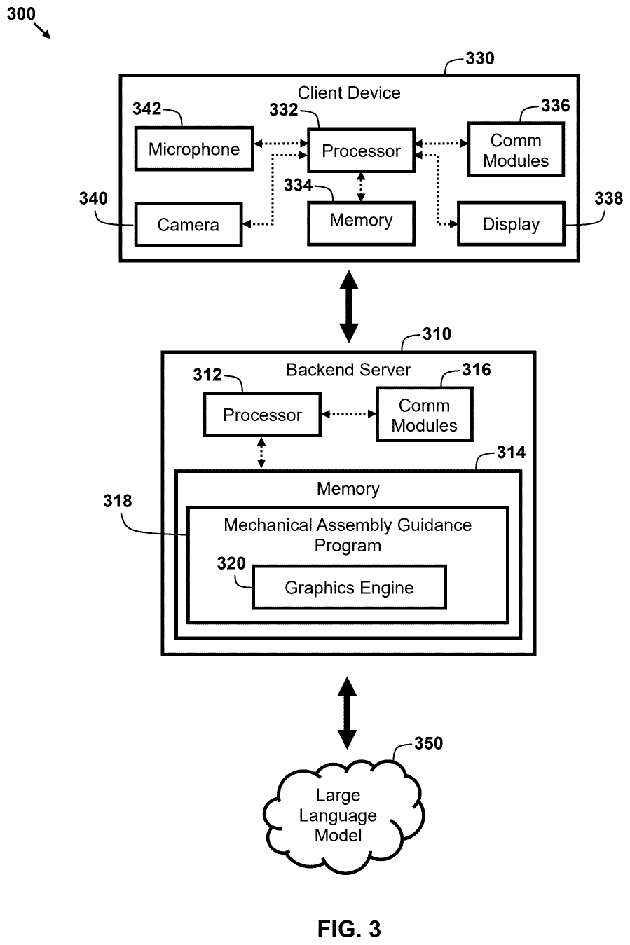

FIG. 3 shows an exemplary embodiment of a mechanical assembly guidance system 300. In the illustrated embodiment, the mechanical assembly guidance system 300 includes a backend server 310 and a client device 330. The client device 330 is configured to enable a user to interact with an application or web interface that communicates with the backend server 310 to provide mechanical assembly guidance with respect to a mechanical apparatus to be assembled. It should be appreciated, however, that in alternative embodiments, the backend server 310 can be omitted and the client device 330 locally provides all of the functions of the backend server 310.

The backend server 310 and/or the client device 330 are configured to leverage a large language model (LLM) to generate the mechanical assembly guidance for the user. In some embodiments, the LLM is a vision language model 350, such as GPT-4 Vision. It should be appreciated that vision language models are multimodal models capable of understanding and processing both images and text, and generally include both an LLM and a vision encoder that converts images or video into text that can be processed by the LLM.

The backend server 310 may include one or more servers configured to serve a variety of functions for the mechanical assembly guidance system 300, including web servers or application servers, depending on the features provided by the mechanical assembly guidance system 300. Each backend server 310 includes, for example, a processor 312, a memory 314, and a network communications module 316. It will be appreciated that the illustrated embodiment of the backend server 310 is only one exemplary embodiment of a backend server 310 and is merely representative of any of various manners or configurations of a personal computer, server, or any other data processing system that is operative in the manner set forth herein.

The processor 312 is configured to execute instructions to operate the backend server 310 to enable the features, functionality, characteristics, and/or the like as described herein. To this end, the processor 312 is operably connected to the memory 314 and the network communications module 316. The processor 312 generally comprises one or more processors that may operate in parallel or otherwise in concert with one another. It will be recognized by those of ordinary skill in the art that a “processor” includes any hardware system, hardware mechanism, or hardware component that processes data, signals, or other information. Accordingly, the processor 312 may include a system with a central processing unit, graphics processing units, multiple processing units, dedicated circuitry for achieving functionality, programmable logic, or other processing systems.

The memory 314 is configured to store program instructions that, when executed by the processor 312, enable the backend server 310 to perform various operations described herein. The memory 314 may be any type of device or combination of devices capable of storing information accessible by the processor 312, such as memory cards, ROM, RAM, hard drives, discs, flash memory, or any of various other computer-readable media recognized by those of ordinary skill in the art. The memory 314 stores a mechanical assembly guidance program 318. The processor 312 executes program instructions of the mechanical assembly guidance program 318 to provide mechanical assembly guidance to a user with respect to assembling a mechanical apparatus. In one embodiment, the mechanical assembly guidance program 318 includes a graphics engine 320 (e.g., Unity3D engine). Particularly, the processor 312 is configured to execute the graphics engine 320 to generate graphical elements for display on the display screen 338 of the client device 330, at least including the animations of assembly steps.

The network communications module 316 may comprise one or more transceivers, modems, processors, memories, oscillators, antennas, or other hardware conventionally included in a communications module to enable communications with various other devices, at least including the client device 330. In particular, the network communications module 316 may include a local area network port that allows for communication with any of various local computers housed in the same or nearby facility. Generally, the backend server 310 communicates with remote computers over the Internet via a separate modem and/or router of the local area network. Alternatively, the network communications module 316 may further include a wide area network port that allows for communications over the Internet. In one embodiment, the network communications module 316 is equipped with a Wi-Fi transceiver or other wireless communications device. Accordingly, it will be appreciated that communications with the backend server 310 may occur via wired communications or via wireless communications. Communications may be accomplished using any of the various known communications protocols.

With continued reference to FIG. 3, the client device 330 (which may also be referred to herein as a “personal electronic device”) may be a desktop computer, a laptop, a smartphone, a tablet, or any similar device. Additionally, the client device 330 may be or incorporate an augmented reality (AR) or virtual reality (VR) headset. The client device 330 includes, for example, a processor 332, a memory 334, at least one network communications module 336, a display screen 338, a camera 340, and a microphone 342.

The processor 332 is configured to execute instructions to operate the client device 330 to enable the features, functionality, characteristics, and/or the like as described herein. To this end, the processor 332 is operably connected to the memory 334, the network communications module 336, and the display screen 338. The processor 332 generally comprises one or more processors that may operate in parallel or otherwise in concert with one another. It will be recognized by those of ordinary skill in the art that a “processor” includes any hardware system, hardware mechanism, or hardware component that processes data, signals, or other information. Accordingly, the processor 332 may include a system with a central processing unit, graphics processing units, multiple processing units, dedicated circuitry for achieving functionality, programmable logic, or other processing systems.

The memory 334 is configured to store data and program instructions that, when executed by the processor 332, enable the client device 330 to perform various operations described herein. The memory 334 may be any type of device capable of storing information accessible by the processor 332, such as a memory card, ROM, RAM, hard drives, discs, flash memory, or any of various other computer-readable media serving as data storage devices, as will be recognized by those of ordinary skill in the art.

The network communications module 336 may comprise one or more transceivers, modems, processors, memories, oscillators, antennas, or other hardware conventionally included in a communications module to enable communications with various other devices, at least including the backend server 310. Particularly, the network communications module 336 generally includes a Wi-Fi module configured to enable communication with a Wi-Fi network and/or Wi-Fi router (not shown). Additionally, the network communications module 336 may include a Bluetooth® module (not shown) configured to enable communication with the backend server 310. Finally, the network communications module 336 may include one or more cellular modems configured to communicate with wireless telephony networks.

The display screen 338 may comprise any of various known types of displays, such as LCD or OLED screens. In some embodiments, the display screen 338 may comprise touch screens configured to receive touch inputs from a user. Alternatively, or in addition, the client device 330 may include additional user interfaces, such as buttons, switches, a keyboard or other keypad, and speakers. The camera 340 may comprise any of various known types of cameras configured to capture images of the environment, each of which comprises a two-dimensional array of pixels. The microphone 342 may comprise any of various known types of microphones configured to capture audio of the environment, at least including audio of the user speaking. The client device 330 may also include a battery or other power source (not shown) configured to power the various components within the client device 330. In one embodiment, the battery of the client device 330 is a rechargeable battery configured to be charged when the client device 330 is connected to a battery charger configured for use with the client device 330.

### Methods for Providing Mechanical Assembly Guidance to a User

A variety of methods, workflows, and processes are described below for enabling the operations and interactions of the mechanical assembly guidance system 300. In these descriptions, statements that a method, workflow, processor, and/or system is performing some task or function refers to a controller or processor (e.g., the processor 312 and/or the processor 312) executing programmed instructions (e.g., the mechanical assembly guidance program 318, the graphics engine 320, or any other programmed instructions) stored in non-transitory computer readable storage media (e.g., the memory 334 or the memory 314) operatively connected to the controller or processor to manipulate data or to operate one or more components in the mechanical assembly guidance system 300 to perform the task or function. Additionally, the steps of the methods may be performed in any feasible chronological order, regardless of the order shown in the figures or the order in which the steps are described.

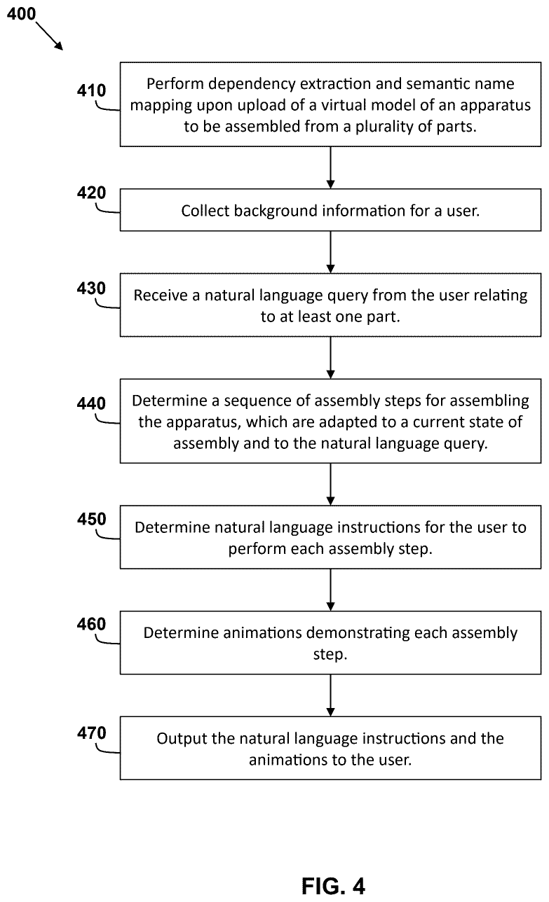

FIG. 4 shows a logical flow diagram for a method 400 for providing mechanical assembly guidance to a user. The method 400 advantageously provides an interactive end-to-end process for on-demand generation of instructional assembly animations, enabling users to explore complex assemblies through natural-language queries and adaptive 3D visualizations. The method 400 advantageously incorporates a dependency-driven animation generation algorithm that derives a part-level dependency graph from CAD geometry, supporting partial, reversible, and query-specific instructional animations.

The method 400 begins with performing dependency extraction and semantic name mapping upon upload of a virtual model of an apparatus to be assembled from a plurality of parts (block 410). Particularly, prior to a session, the processor 312 of the backend server 310 and/or the processor 332 of the client device 330 is configured to receive virtual model(s) (e.g., a CAD model) of a mechanical apparatus that the user wants to assemble. The virtual model(s) define a plurality of parts required to assemble the mechanical apparatus. The virtual model(s) may, for example, be uploaded by the user to the backend server 310 or selected from a menu of virtual models that have already been processed previously. Based on the virtual model(s), the processor 312 and/or the processor 332 perform dependency extraction and semantic name mapping with respect to the virtual model(s).

It should be appreciated that many animation systems rely on fixed assembly sequences, which limits their ability to respond to user interactions or alternate assembly paths. However, to generate realistic and structurally accurate animations, the system needs to understand how each part in an assembly is assembled or disassembled relative to others and how it moves in 3D space. Assembly-by-disassembly algorithms can be used to understand how each part in an assembly is assembled or disassembled. However, these algorithms typically produce fixed sequences for assembly or disassembly. Moreover, for user-driven, on-demand adaptive animations, a fixed sequence is suboptimal. User interactions often require flexibility to accommodate dynamic changes in the assembly state or alternate paths based on user queries and actions.

The mechanical assembly guidance system 300 solves these challenges by using a motion planning approach to automatically extract these inter-part relations and dependencies, instead of generating a single fixed sequence. To perform dependency extraction, the processor 312 and/or the processor 332 determines respective assembly dependencies for each respective part in the plurality of parts. In each case, the assembly dependencies are a list of parts from the plurality of parts that must be assembled in the mechanical apparatus prior to assembling the respective part in the mechanical apparatus. Given a virtual model, the processor 312 and/or the processor 332 simulates disassembly paths for each part and then reverses them to compute valid assembly paths. The output is a set of motion paths and a graph of part relationships that captures which parts must be added or removed before others. This algorithm runs once when virtual model(s) for a new assembly are uploaded and produces reusable data that supports all future user queries and animations.

For the sake of clarity, the dependency extraction problem is defined more precisely. Let the plurality of parts used to assemble a mechanical apparatus consist of M parts {p₁, . . . , p_{M}}. The assembled and disassembled states of each part of the mechanical apparatus are summarized by

$${s}_{0}^{i} = \{ {t}_{0}^{i} , {r}_{0}^{i} \} ,$$

which defines a part's position and orientation when assembled in the mechanical apparatus, and by

$${s}_{n}^{i} = \{ {t}_{n}^{i} , {r}_{n}^{i} \} ,$$

which defines a part's position and orientation when disassembled (removed) from the mechanical apparatus. For each part, a disassembly path

$${P}_{D}^{i} = \{ {s}_{t}^{i} \vert 0 \leq t \leq n \}$$

can be defined, which is a collision-free trajectory transforming the part pᵢ from

$${s}_{0}^{i} to {s}_{n}^{i} .$$

For each part a dependency set Dⁱ⊆{p₁, . . . , p_{M}}\{pᵢ} can be defined, which is the set of parts that must be removed before the part pᵢ can be disassembled. Based on the dependency sets Dⁱ, a global dependency graph D={D¹, . . . , D^{M}} can be formed, where an edge (pⱼ→pᵢ) exists⇔pⱼ∈Dⁱ. Based on the global dependency graph D, a valid disassembly sequence S_{D}= [symbol] pᵢ_{₁}, . . . , pᵢ_{_{M}} [symbol] can be determined that satisfies all dependencies. Likewise, a valid assembly sequence S_{A}=reverse (S_{D}) ensures no part is added before its dependencies are in place.

In the context of assembly and disassembly planning, dependencies define the relationships between parts, dictating whether one part can be removed (disassembly) or added (assembly) based on the state of other parts. The concept of dependencies is inherently bidirectional: what constitutes a dependency in disassembly reverses in assembly. For example, during disassembly, if Part A obstructs Part B, then Part B depends on the prior removal of Part A. Conversely, during assembly, the dependency is reversed: Part A cannot be added until Part B is already in place. Thus, in disassembly planning, the dependency of Part B would include Part A (Part B depends on Part A's removal). In assembly planning, the dependency of Part A would include Part B (Part A depends on Part B being added first). This bidirectional nature of dependencies allows the mechanical assembly guidance system 300 to adaptively handle both assembly and disassembly tasks while maintaining logical consistency.

In summary, to determine the assembly dependencies for each part, the processor 312 and/or the processor 332 determines, for each respective part, a respective motion path for assembling the respective part in the mechanical apparatus. Next, the processor 312 and/or the processor 332 checks, for each respective part, if the respective part would collide with other parts while assembling the respective part in the mechanical apparatus, and determines the respective assembly dependencies for each respective part based on these collisions. Finally, the processor 312 and/or the processor 332 forms a dependency graph based on the respective assembly dependencies for each of the plurality of parts.

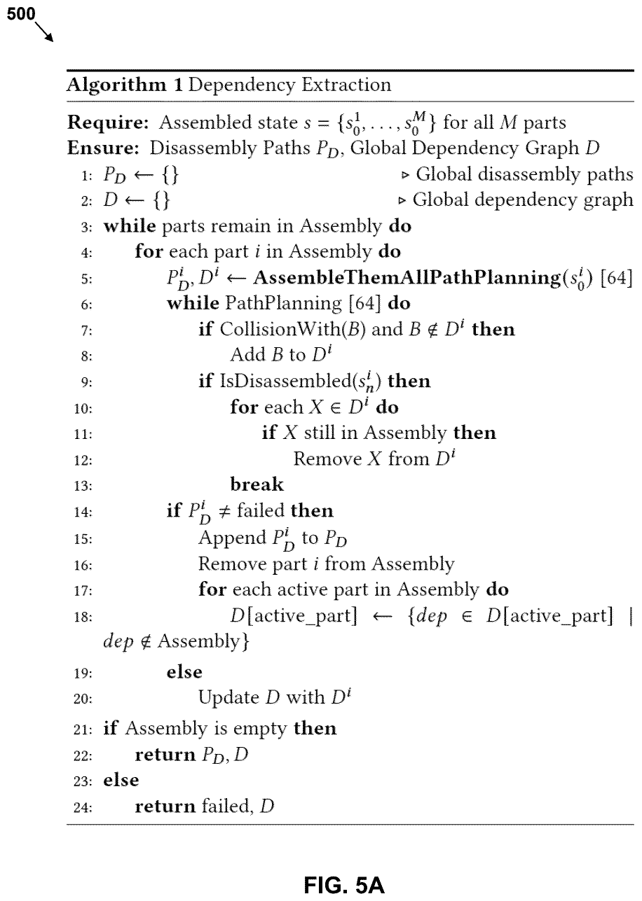

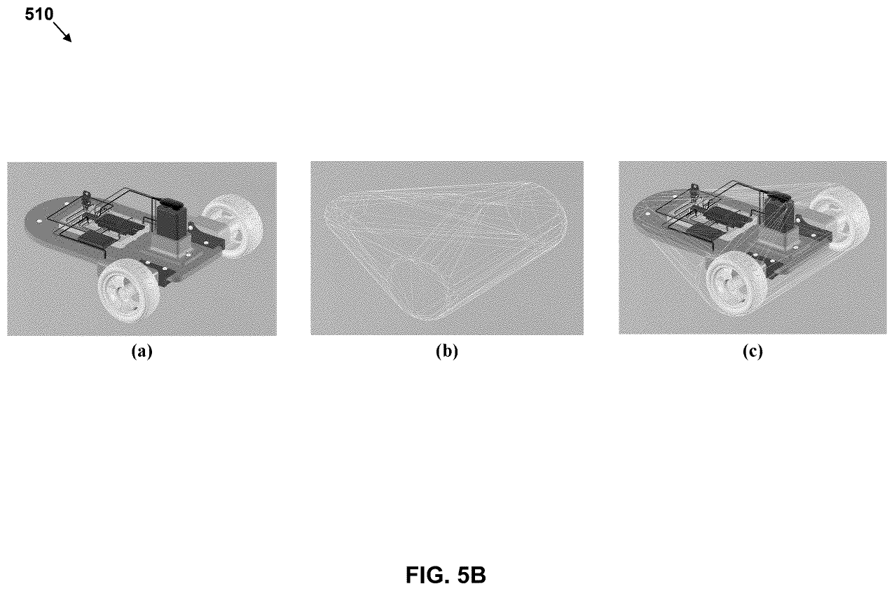

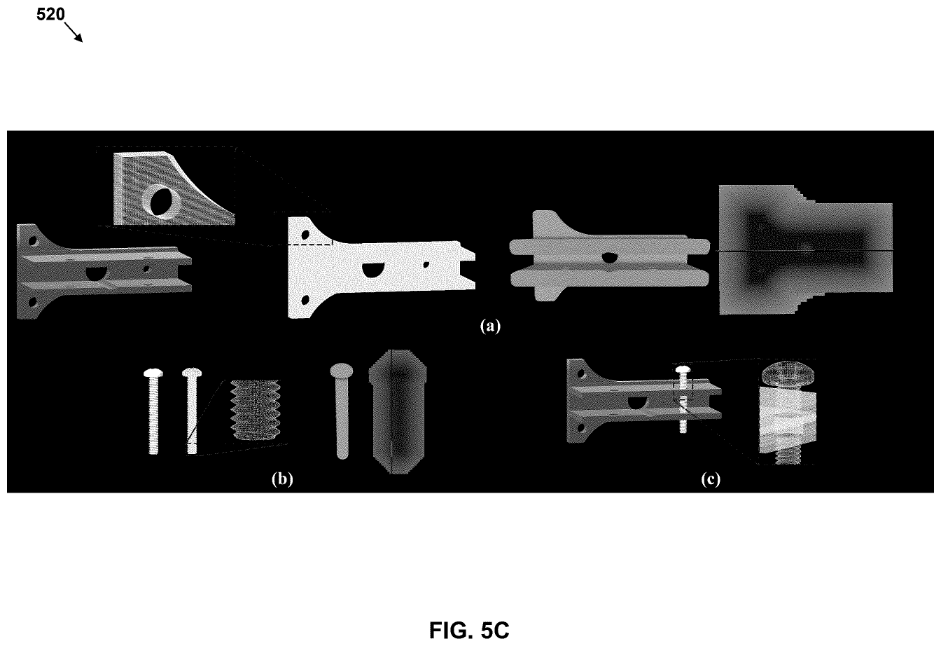

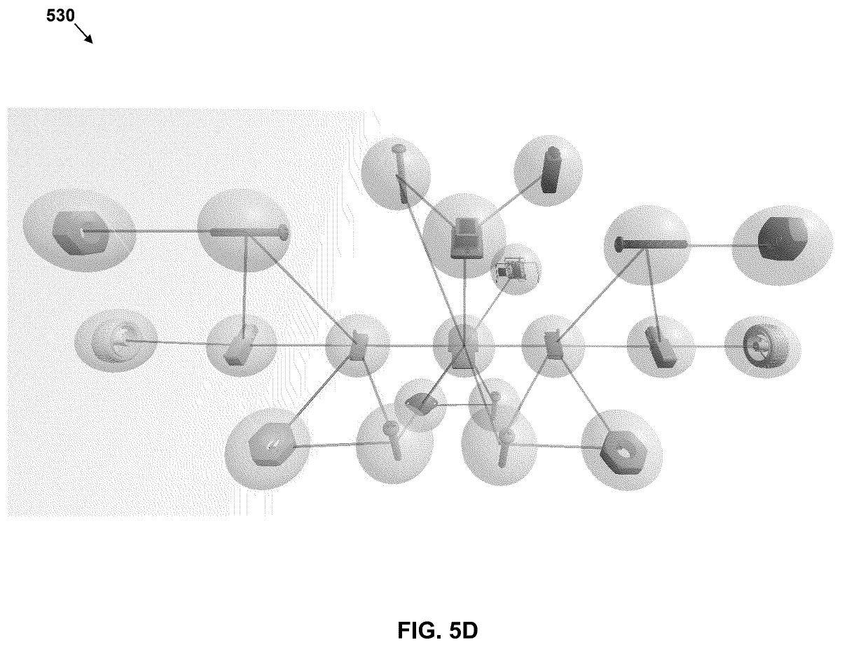

FIG. 5A shows pseudocode 500 for a dependency extraction algorithm (Algorithm 1). Particularly, using the dependency extraction algorithm, the processor 312 and/or the processor 332 simulates the motion of an individual part from its assembled state

$$( {s}_{0}^{i} )$$

to a disassembled state

$$( {s}_{n}^{i} )$$

while recording intermediate dependencies. The processor 312 and/or the processor 332 stores the resulting motion paths in the memory 314 or memory 334 as a JSON file. A dependency is recorded if a part B obstructs the motion of the current part i, with this obstruction detected through collision checks during the simulation. This step captures an initial set of dependencies but does not represent the final dependency graph. Once the part is successfully disassembled, the processor 312 and/or the processor 332 reevaluates its dependencies (Dⁱ) by removing parts that are still present in the mechanical apparatus. Since the part was successfully removed before these remaining parts, they cannot logically be its dependencies and are therefore discarded from D′. If no valid disassembly path is found within the given time or step constraints, the processor 312 and/or the processor 332 returns a failure signal along with any partially computed dependencies, allowing for potential fallback handling during sequence planning or subsequent path planning iterations.

For each part i in the mechanical apparatus, the processor 312 and/or the processor 332 calls a path planning method to compute

$${P}_{D}^{i}$$

(the disassembly path for i) and Dⁱ (its dependencies). To these ends, in one embodiment, the processor 312 and/or the processor 332 implements the path planning method disclosed in the publication “Assemble them all: Physics-based planning for generalizable assembly by disassembly” by Tian et al. (2022). If a valid path is found, the processor 312 and/or the processor 332 appends

$${P}_{D}^{i}$$

to the global disassembly sequence (P_{D}), and the part i is removed from the mechanical apparatus. After removing a part, the processor 312 and/or the processor 332 updates the dependencies of all remaining parts. Specifically, for each active part still in the mechanical apparatus, the processor 312 and/or the processor 332 removes any dependencies in D referencing other active parts, ensuring that only previously removed parts remain as valid dependencies. This ensures that the dependency graph reflects the current state of assembly of the mechanical apparatus at each step and maintains logical consistency. If the path planning for a part fails, the processor 312 and/or the processor 332 incorporates its partial dependencies into the global dependency graph (D), allowing these constraints to guide subsequent planning iterations.

In one embodiment, the processor 312 and/or the processor 332 leverages the physics-based simulation capabilities of the graphics engine 320, incorporating convex hull mesh, mesh colliders, and signed distance fields for all parts of the mechanical apparatus to detect collisions and calculate motion paths.

FIG. 5B shows visualizations 510 of the toy car assembly mesh generated by the graphics engine 320. Illustration (a) shows the fully assembled toy car model. Illustration (b) shows a convex hull mesh generated for collision detection. Illustration (c) shows an overlay of the toy car assembly with its corresponding convex hull mesh to illustrate the assembly sequence planning and motion constraints.

FIG. 5C shows visualizations 520 of part meshes and signed distance fields for collision detection and disassembly path planning. Illustration (a) shows a motor mount highlighting geometric details. Illustration (b) shows a screw showcasing thread precision. Illustration (c) shows an assembly of the motor mount and screw demonstrating their interaction through meshes for accurate collision detection and dependency computation.

With reference again to FIG. 5A, the processor 312 and/or the processor 332 repeats this process until all parts are disassembled, at which point the processor 312 and/or the processor 332 outputs the full disassembly sequence and disassembly path (P_{D}) and the dependency graph (D). This progressive and dependency-aware approach ensures the system can adapt dynamically to changing assembly states, providing the flexibility needed for user-driven animations. The output of the dependency extraction algorithm is stored in a structured JSON format, representing the static dependency graph D={D¹, D², . . . , D^{M}} where each entry Dⁱ lists the parts that must be added prior to assembling part pᵢ. This JSON file forms the backbone of the sequence generator 130, serving as a reference that encodes the structural constraints of the mechanical apparatus.

FIG. 5D shows a visual representation of an extracted part dependency graph 530. This part dependency graph 530 encodes the structural constraints across all parts, enabling the system to dynamically generate animation sequences without requiring a fixed path upfront. Each node is a part, and edges indicate directional assembly constraints. This part dependency graph 530 enables dynamic sequence planning at runtime based on user interactions.

With reference again to FIG. 4, in addition to performing dependency extraction, the processor 312 and/or the processor 332 performs semantic name mapping with respect to the virtual model(s). Particularly, the processor 312 and/or the processor 332 receives images of each part in the plurality of parts and of the mechanical apparatus in a fully assembled state. In some embodiments, the processor 312 and/or the processor 332 renders these images automatically based on the virtual model(s). Alternatively, the images might be captured of real-world parts by the user using the camera 340. Based on these images, the processor 312 and/or the processor 332 determines semantic names for the plurality of parts based on the images using the vision language model 350, such as GPT-4 Vision.

It should be appreciated that the plurality of parts are usually named using technical labels from the virtual model(s), which are often confusing to users. For example, a part named ‘M2.5X0.45_1’ might be a simple screw, but a novice wouldn't recognize what the part is from that label. To make narration user-friendly, the mechanical assembly guidance system 300 maps each technical or abstract part name to natural-language alternatives like “screw” or “Phillips head screw.” In some embodiments, the processor 312 and/or the processor 332 determines these semantic names automatically using the vision language model 350, which analyzes the images of individual parts alongside a full image of the mechanical apparatus.

In general, the vision language model 350 is implemented by a remote third-party server rather than being executed directly by the client device 330 or by the backend server 310. Instead, the mechanical assembly guidance system 300 interfaces with the vision language model 350 via Internet communications using an API. Particularly, once the images are collected, the processor 312 operates the network communications module 316 and/or the processor 332 operates the network communications module 336 to transmit a message including the images and a corresponding prompt to a server hosting the vision language model 350. The prompt includes instructions detailing how the context information should be used in generating a response. As an example, the prompt might be “In the context of a {assembly_name} assembly, shown in {assembly_image}, this is an {image} of an individual part taken from Unity. In Unity or CAD, this object is named ‘{game_object_name}’. Can you provide three possible user-friendly natural names for this object that best describe this part?” In response, the processor 312 receives via the network communications module 316 and/or the processor 332 receives via the network communications module 336 a response from the vision language model 350 that includes text that is responsive to the prompt, and which includes semantic names for the plurality of parts. However, in alternative embodiments, the backend server 310 and/or the client device 330 stores the vision language model 350 and executes the vision language model 350 to generate the semantic names locally.

The processor 312 and/or the processor 332 stores the resulting mappings in the memory 314 or memory 334 as a JSON file. This JSON file is used throughout the mechanical assembly guidance system 300 to translate between technical part names (used by the graphics engine 320) and natural names (used in narration). This one-time mapping ensures consistency and efficiency across all future interactions involving the same assembly.

The method 400 continues with collecting background information for a user (block 420). Particularly, at the start of a user session with the mechanical assembly guidance system 300, the processor 312 and/or the processor 332 receive natural language inputs from the user that provide background information, such as his or her experience with mechanical assemblies. The processor 312 and/or the processor 332 stores this background information in the memory 314 or memory 334 as user profile information, which will be used to adjust the level of detail and pacing of instructions to match the skill level of the user 110.

It should be appreciated that many instructional systems treat all users the same, ignoring differences in experience or learning needs. This can make the instructions too slow for experts or too confusing for beginners. To address this, a user session with the mechanical assembly guidance system 300 begins each session by asking the user a few quick questions about their background, such as age, experience with assemblies, and domain knowledge. Prior research has shown that even lightweight background information can be highly effective for delivering personalized instruction and adapting content to the user's needs.

The user profiling results are used to adjust how instructions are delivered. For example, new users receive detailed explanations and slower animations that explain each step clearly. In contrast, experienced users get faster-paced instructions with simpler language. This helps match the guidance to each user's comfort level. As a result, users receive instructions that are easier to follow, more relevant to their skill level, and better aligned with how they prefer to learn.

The method 400 continues with receiving a natural language query from the user relating to at least one part (block 430). Particularly, the processor 312 and/or the processor 332 receives a natural language query from the user. The natural language query includes a question relating to at least one part from the plurality of parts of the mechanical apparatus that is to be assembled from the plurality of parts. In at least one embodiment, the user provides the natural language query by speaking into the microphone 342, and the processor 332 operates the microphone 342 to record spoken audio of the natural language query. The processor 312 and/or the processor 332 converts the spoken audio into text using a speech transcription model, such as OpenAI's Whisper-1 model.

It should be appreciated that users often have specific questions while assembling a product, like what part to install next or where a removed part belongs, but traditional systems don't let users ask questions in natural language or get tailored answers. To solve this, the mechanical assembly guidance system 300 lets users speak freely during the session. Next, in at least some embodiments, the processor 312 and/or the processor 332 uses the query analysis module 120 to classify a query type of the natural language query according to a number of parts in the plurality of parts to which the question relates and/or whether the question relates to assembling the mechanical apparatus.

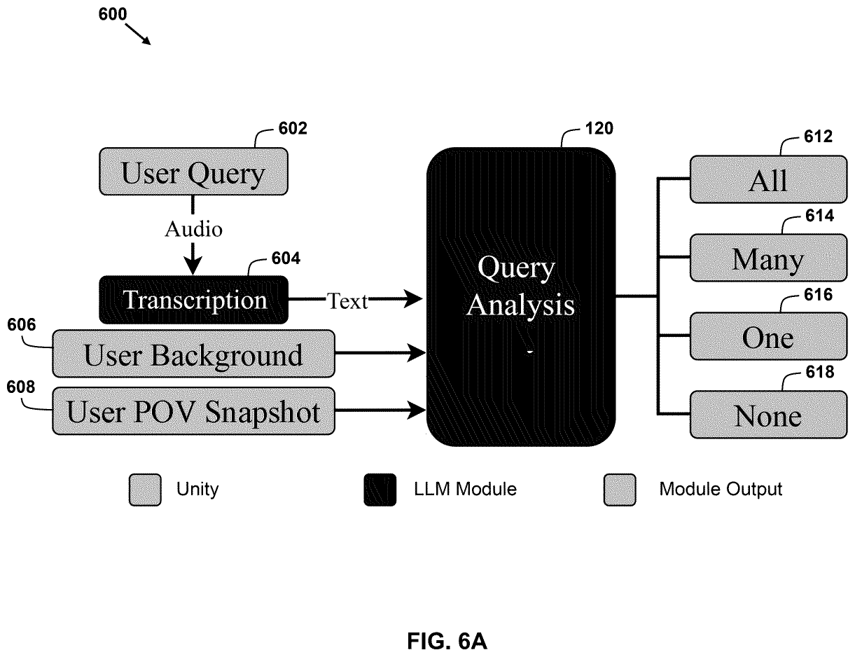

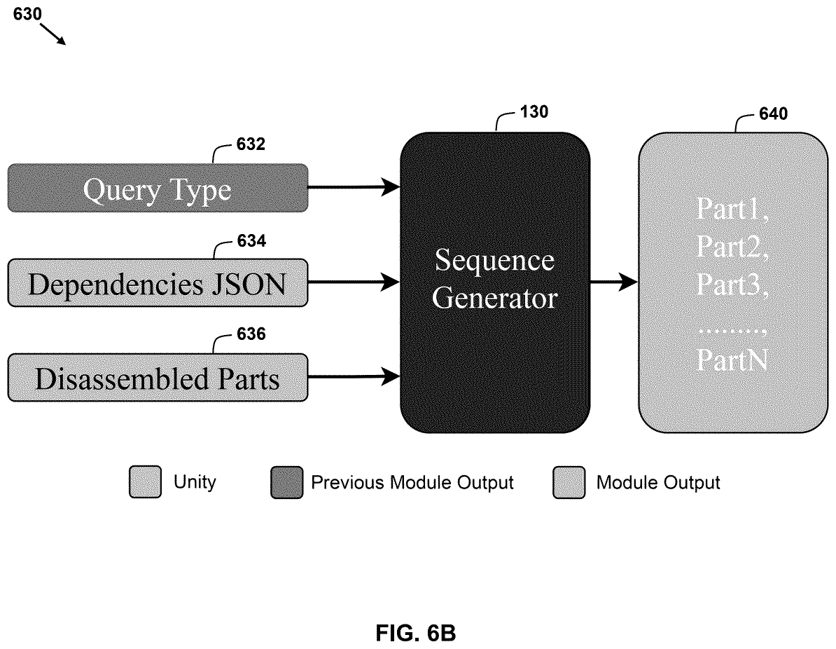

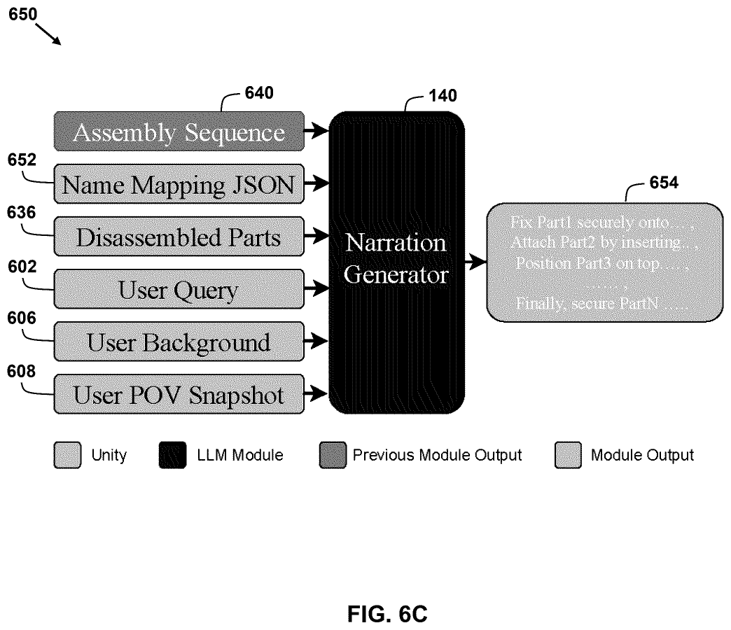

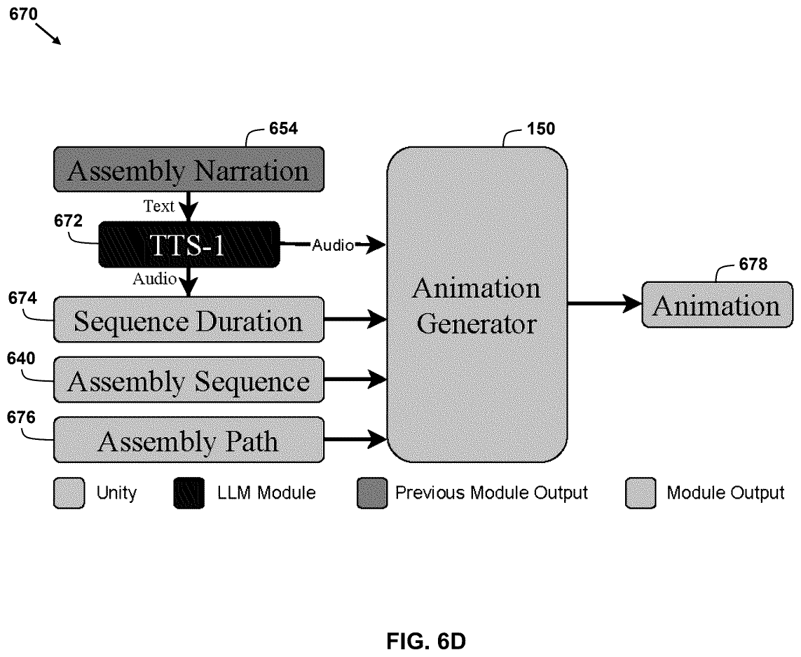

FIG. 6A shows a detailed workflow 600 of the query analysis module 120 for classifying the query type of a natural language query received from the user. The natural language query 602 is transcribed using the speech transcription model 604 (e.g., OpenAI's Whisper-1), and the resulting text is sent to the vision language model 350 along with the user background information 606 (i.e., the user profile information stored from block 420) and a user POV snapshot 608 (i.e., an image of the mechanical apparatus from the user's point of view). The user POV snapshot 608 may, for example, comprise a screenshot from the exemplary user interface 180. Alternatively, the user POV snapshot 608 may comprise an image of the mechanical apparatus captured by the camera 340.

Based on the text transcription of the natural language query 602, the user background information 606, the user POV snapshot 608, the processor 312 and/or the processor 332 uses the vision language model 350 to classify the query type of the natural language query according to a number of parts in the plurality of parts to which the question relates and/or whether the question relates to assembling the mechanical apparatus.

Particularly, the processor 312 and/or the processor 332 classifies the natural language query as an “All” query type 612 in response to the question relating to assembling all of the plurality of parts. The “All” query type 612 includes questions that require animating the full assembly (e.g., “How do I assemble this?”). The processor 312 and/or the processor 332 classifies the natural language query as a “Many” query type 614 in response to the question relating to assembling multiple parts in the plurality of parts. The “Many” query type 614 includes questions about several parts, usually ones the user has removed (e.g., “How do I put the removed parts back?”). The processor 312 and/or the processor 332 classifies the natural language query as a “One” query type 616 in response to the question relating to assembling a single part in the plurality of parts. The “One” query type 616 includes questions about a specific part (e.g., “Where does this screw go?”). The processor 312 and/or the processor 332 classifies the natural language query as a “None” query type 618 in response to the question not being related to assembling the mechanical apparatus. The “None” query type 618 includes conceptual questions that don't require animation (e.g., “What does this part do?”).

In general, the vision language model 350 is implemented by a remote third-party server rather than being executed directly by the client device 330 or by the backend server 310. Instead, the mechanical assembly guidance system 300 interfaces with the vision language model 350 via Internet communications using an API. Particularly, the processor 312 operates the network communications module 316 and/or the processor 332 operates the network communications module 336 to transmit a message including the text transcription of the natural language query 602, the user background information 606, the user POV snapshot 608, and a corresponding prompt to a server hosting the vision language model 350. The prompt includes instructions detailing how the context information should be used in generating a response. As an example, the prompt might be “Classify the type of mechanical assembly animation required for an {assembly_name} assembly based on the user's question {user_query}, background {user_background}, and POV {POV_Snapshot}. Categories: “One”: Animation for a specific part. “Many”: Animation for removed parts. “All”: Animation for the entire assembly. “None”: No animation required.” In response, the processor 312 receives via the network communications module 316 and/or the processor 332 receives via the network communications module 336 a response from the vision language model 350 that includes text that is responsive to the prompt, and which includes the query type classification. However, in alternative embodiments, the backend server 310 and/or the client device 330 stores the vision language model 350 and executes the vision language model 350 to generate the query type classification locally.

As discussed in greater detail below, this classification step determines what happens next. If no animation is needed (None), the mechanical assembly guidance system 300 generates only a verbal explanation. If an animation is needed (One, Many, or All), the mechanical assembly guidance system 300 forwards the query to the sequence generator 130 to determine which parts should be animated and in what order.

This allows the mechanical assembly guidance system 300 to support a wide range of user questions in a flexible and responsive way. Crucially, the query classification goes beyond simple part selection. The None category enables the system to handle conceptual and explanatory questions entirely through narration, while the Many category allows the system to infer which parts the user is referring to based on recent interaction history rather than requiring explicit naming. This context-sensitive interpretation is enabled by passing the user background information 606 and the user POV snapshot 608 alongside the transcription of the natural language query 602 to the vision language model 350, allowing the vision language model 350 to resolve ambiguous references such as “this” or “these parts” without requiring the user to know technical part names.

With reference again to FIG. 4, the method 400 continues with determining a sequence of assembly steps for assembling the apparatus, which are adapted to a current state of assembly and to the natural language question (block 440). Particularly, the processor 312 and/or the processor 332 determines a sequence of assembly steps for assembling the mechanical apparatus based on the query type (of the natural language query), based on the assembly dependencies of the plurality of parts (defined by the static dependency graph D), and based on a subset of the plurality of parts that have not yet been assembled in the mechanical apparatus.

It should be appreciated that the subset of the plurality of parts that have not yet been assembled in the mechanical apparatus (i.e., the ‘disassembled parts’) is representative of the current state of assembly of the mechanical apparatus. The processor 312 and/or the processor 332 can determine the subset of the plurality of parts that have not yet been assembled in the mechanical apparatus based on the state of a virtual model for the mechanical apparatus. As discussed above with respect to FIG. 1C, the user interface 180 includes a virtual model of a mechanical apparatus 182 that is to be assembled. The user can interact with this virtual model as he or she assembles the mechanical apparatus in the real world (i.e., the user updates the virtual model to reflect completed assembly steps). In this way, the state of the virtual model reflects the current state of assembly of the mechanical apparatus. The currents state of each part in the virtual model is known within the graphics engine 320 that is used to provide the user interface 180. The processor 312 and/or the processor 332 tracks the current state of assembly by maintaining a structured representation of all parts and their spatial relationships. Parts are considered “assembled” when their position and orientation satisfy predefined geometric and constraint conditions (e.g., alignment, contact, or collision-based placement checks). The processor 312 and/or the processor 332 then compares the current configuration of the assembly against the dependency graph to determine which parts remain unassembled or are available for subsequent assembly steps.

However, in alternative embodiments, processor 312 and/or the processor 332 can determine the subset of the plurality of parts that have not yet been assembled in the mechanical apparatus in an automatic manner that does not depend on manual user manipulations of a virtual model of a mechanical apparatus 182. Instead, the processor 312 and/or the processor 332 can determine the subset of the plurality of parts that have not yet been assembled in the mechanical apparatus using vision-based inputs, such as the user POV snapshot 608, or using other sensor or tracking data reflecting the state of the real-world mechanical apparatus

Users often ask questions like “Where does this part go?” or “Can you show the rest of the assembly steps?” To answer these meaningfully, the system must decide which parts to animate and in what order. This can be challenging because assembly tasks must follow some steps to complete, and users may interact with the assembly in unexpected ways, like removing parts out of order or skipping steps entirely.

While the static dependency graph D encodes structural constraints of the mechanical apparatus, it does not account for real-time user behavior. Users often remove parts out of order, skip steps, or inspect specific components. To handle these deviations, the sequence generator 130 incorporates a lightweight micro-adaptive logic that dynamically adjusts the part sequence based on user actions. These user actions are reflected in the identified subset of the plurality of parts that have not yet been assembled in the mechanical apparatus.

FIG. 6B shows a detailed workflow 630 of the sequence generator 130 for dynamically determining a sequence of assembly steps for assembling the mechanical apparatus. The processor 312 and/or the processor 332 utilizes the sequence generator 130 to determine a valid and context-aware order for part animations. Advantageously, the sequence generator 130 considers the user's current query, their recent interactions with the assembly, and the physical constraints of the model. The output is a list of parts that can be animated in sequence, ensuring that all instructions are feasible and relevant to the user's situation.

To provide the right animation for each query, the processor 312 and/or the processor 332 computes a new sequence of part movements every time a user asks a question. This planning happens on the fly, taking into account the user's current context and the system's understanding of the mechanical apparatus. The goal is to generate a valid, coherent animation sequence that respects both the physical constraints of the mechanical apparatus and the specific situation the user is in, whether parts are missing, removed out of order, or queried individually. This step ensures that animations stay relevant, logically consistent, and tailored to the user's current progress and intent.

To handle this, the mechanical assembly guidance system 300 generates a new part sequence at runtime based on three factors. Particularly, based on the query type 632, the dependencies JSON 634 (which stores the static dependency graph D), and the disassembled parts 636 (i.e., the subset of the plurality of parts that have not yet been assembled in the mechanical apparatus), the processor 312 and/or the processor 332 determines a sequence of assembly steps for assembling the disassembled parts 604 in the mechanical apparatus.

This allows the system to respond to user behavior in real time, a strategy known as micro-adaptiveness. If a user removes a part manually or skips a step, the system updates its internal model and re-evaluates which parts can be assembled next based on the updated dependencies. For example, if the motor and wheel assemblies depend on the motor mount being in place and the user removes the motor mount, the dependencies of the motor and wheels are broken, making them eligible for reassembly.

The processor 312 and/or the processor 332 determines the sequence of assembly steps 640 in the form of a topologically sorted list of parts adapted to the user's query and current context. This sequence is then passed to the narration generator 140 and to the animation engine 150 to generate step-by-step instructions and synchronized animations that stay consistent with the user's real-time actions.

With reference again to FIG. 4, the method 400 continues with determining natural language instructions for the user to perform each assembly step (block 450). Particularly, the processor 312 and/or the processor 332 determines, for each respective assembly step in the sequence of assembly steps, respective natural language text instructions for the user to perform the respective assembly step.

It should be appreciated that users often need explanations that match their level of expertise and the specific situation they're in, especially when they ask follow-up questions or interact with the assembly in unexpected ways. However, most systems provide generic instructions, ignoring who the user is or what they're currently doing. The mechanical assembly guidance system 300 addresses this by generating clear, personalized verbal explanations that match the user's expertise, background, and real-time actions. The processor 312 and/or the processor 332 takes in the sequence of assembly steps, the natural language query spoken by the user, and the image of the mechanical apparatus from the user's point of view to produce one-paragraph explanations that accompany the corresponding animation.

FIG. 6C shows a detailed workflow 650 of the narration generator 140 for dynamically generating natural language text instructions for the user to perform each assembly step. The processor 312 and/or processor 332 uses the vision language model 350 to determine natural language text instructions 654 for the user to perform each assembly step based on the natural language query 602, the user background information 606 (i.e., the user profile information stored from block 420), the user POV snapshot 608 (i.e., the image of the mechanical apparatus from the user's point of view), the disassembled parts 636 (i.e., the subset of the plurality of parts that have not yet been assembled in the mechanical apparatus), and a semantic name mapping JSON 652 (which stores the user-friendly, natural-language names for each part in mechanical apparatus).

Even when the user's question is vague, like “How do I put this back?”, by using the vision language model 350, the narration generator 140 resolves ambiguity using context cues. As an example, the vision language model 350 might be instructed to first check if the user is holding a part in the user POV snapshot 608. If not, the vision language model 350 might be instructed to look at where the user is looking in the scene. If neither is available, the vision language model 350 might be instructed to analyze the disassembled parts 636 along with the user POV snapshot 608. In at least some embodiments, the vision language model 350 is instructed to incorporate the semantic names for the parts in the natural language text instructions 654.

In general, the vision language model 350 is implemented by a remote third-party server rather than being executed directly by the client device 330 or by the backend server 310. Instead, the mechanical assembly guidance system 300 interfaces with the vision language model 350 via Internet communications using an API. Particularly, the processor 312 operates the network communications module 316 and/or the processor 332 operates the network communications module 336 to transmit a message including the natural language query 602, the user background information 606, the user POV snapshot 608, the disassembled parts 636, the semantic name mapping JSON 652, and a corresponding prompt to a server hosting the vision language model 350. The prompt includes instructions detailing how the context information should be used in generating a response. As an example, the prompt might be “You are an AI assistant helping a {user_background} (age {user_age}) who is a {user_expertise} with assembling a {assembly_name}. The user asked: {user_query}. Provide a short, single-paragraph explanation of the assembly process. Replace all CAD names in the sequence ({sequence}) with their natural names using the following mappings: {name_mappings}. Describe each part's role briefly in one sentence as it is assembled. Maintain a flowing narrative without numbered steps. Use transition words like “then,” “next,” or “afterward.” Do not combine descriptions for multiple parts in one sentence. Ensure the number of sentences matches the number of parts in the sequence ({len(sequence)}).” In response, the processor 312 receives via the network communications module 316 and/or the processor 332 receives via the network communications module 336 a response from the vision language model 350 that includes text that is responsive to the prompt, and which includes the natural language text instructions 654. However, in alternative embodiments, the backend server 310 and/or the client device 330 stores the vision language model 350 and executes the vision language model 350 to generate the natural language text instructions 654 locally.

The vision language model 350 generates the natural language text instructions 654 in the form of a coherent narrative that walks the user through the assembly steps in a clear and intuitive order. For queries involving a specific part, the explanation is focused and concise.

When the query type doesn't require animation (“None”), the mechanical assembly guidance system 300 skips the animation engine 150 (and block 460 of the method 400) and delivers only a verbal explanation tailored to the user's conceptual or functional question. In all other cases, the natural language text instructions 654 are passed to the animation engine 150 for synchronized playback. This design allows the mechanical assembly guidance system 300 to flexibly support a wide range of instructional needs with both verbal and visual guidance.

With reference again to FIG. 4, the method 400 continues with determining animations demonstrating each assembly step (block 460). Particularly, the processor 312 and/or the processor 332 determines, for each respective assembly step in the sequence of assembly steps, a respective animation that demonstrates the respective assembly step.

FIG. 6D shows a detailed workflow 670 of the animation engine 150 for dynamically generating animations that demonstrate each assembly step. The processor 312 and/or processor 332 converts the natural language text instructions 654 for each respective assembly step into spoken audio instructions using a text-to-speech algorithm 672 (TTS-1) and determines sequence durations 674 of the spoken audio instructions for each assembly step. The processor 312 and/or processor 332 uses the animation engine 150 to generate the animations that demonstrate each assembly step based on the sequence durations 674, the sequence of assembly steps 640, and the assembly motion paths 676 for assembling each part in the mechanical apparatus.

The processor 312 and/or the processor 332 retrieves each part's assembled state, disassembled state, and motion path from the output of the dependency extraction algorithm. The processor 312 and/or the processor 332 generates each respective animation by animating the respective part to move along the respective motion path for assembling the respective part in the mechanical apparatus. These motion paths were pre-computed earlier during the dependency extraction process and stored in the memory 314 or memory 334 as a JSON file. The processor 312 and/or the processor 332 generates animations 678 for each part according to the sequence provided by the sequence generator 130. The parts move along their predefined motion paths with smooth transitions, enabling accurate and visually coherent animations that reflect the real structure and assembly logic.

The quantity of animations that are generated is also tailored based on the user's query type. Particularly, for the “All” or “Many” query types, processor 312 and/or the processor 332 generates animations 678 for the entire assembly process or for multiple parts in order. However, for the “One” query type, the processor 312 and/or the processor 332 generates animations 678 only for a single part and ensures that any required dependencies are handled correctly. Finally, for the “None” query type, the processor 312 and/or the processor 332 does not generate any animations. This selective approach ensures that animations are used when they add value and skipped when not needed, keeping the experience efficient and focused.

With reference again to FIG. 4, the method 400 continues with outputting the natural language instructions and the animations to the user (block 470). Particularly, the processor 332 operates the display screen 338 to output the natural language text instructions and the animation for one or more of the assembly steps in the sequence of assembly steps. In some embodiments, the processor 332 operates a speaker of the client device 330 (not shown) to output the spoken audio instructions. In the case of the “None” query type, the processor 312 and/or the processor 332 only operates the display screen 338 and/or the speaker to output the spoken audio instructions, without any animations.

It should be appreciated that, even when users receive the right instructions, animations can be confusing if they aren't synchronized with narration or if parts move in unrealistic ways. Misaligned visuals or poor camera angles can reduce clarity and make it harder to follow the steps. To solve this, the processor 312 and/or the processor 332 converts the part sequence and narration into synchronized animations. The animation engine 150 uses scripts with the graphics engine 320 to animate each part along its motion path while ensuring that the visuals match the narration in both timing and content. In particular, the processor 332 operates the display screen 338 and/or the speaker to output the spoken audio instructions and the animations for one or more assembly steps in a synchronized manner, depending on the respective duration of the spoken audio instructions for each assembly step. In other words, the animations are displayed in a manner that aligns precisely with the durations of the spoken audio instructions. This synchronization can be achieved either by time-stretching a respective animation for a respective assembly step to match the duration of the spoken audio instructions for that step or by simply starting the respective animation at the same time as the respective spoken audio instructions.

While synchronized movement and narration are crucial for instructional clarity, the way animations are visually presented also plays a key role. Poor camera angles or occluded parts can hinder understanding, especially in 3D assemblies. To enhance visibility and ensure clarity, the mechanical assembly guidance system 300 includes intelligent camera control modes that automatically frame each animation step from optimal viewpoints.

To ensure each animation is easy to follow, the mechanical assembly guidance system 300 automatically adjusts the camera to show each part from the best possible angle. These camera positions are computed ahead of time, during the preprocessing stage, when a new assembly is uploaded, using part trajectories

$${P}^{i} = \{ {s}_{0}^{i} , … , {s}_{n}^{i} \}$$

generated by the dependency extraction algorithm, and determined according to the camera placement algorithm.

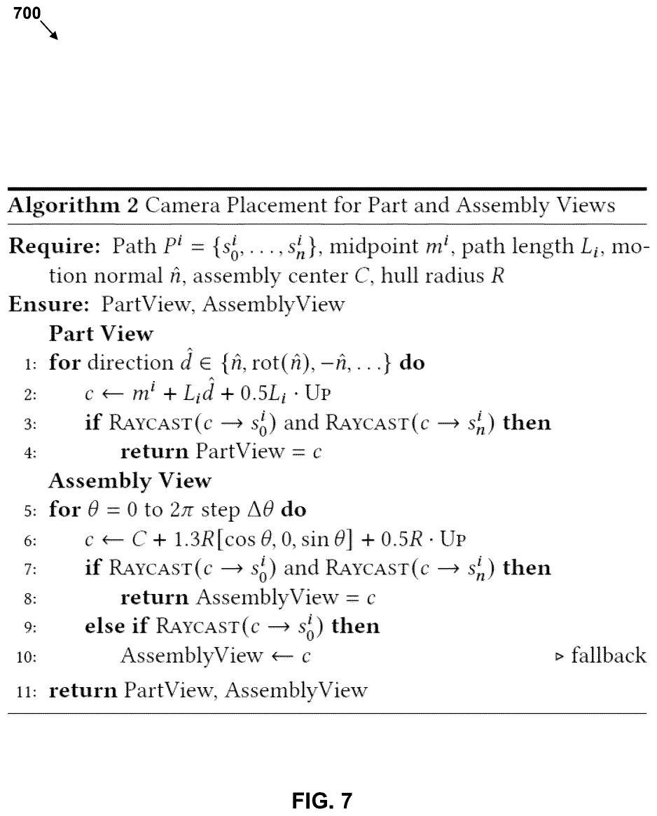

FIG. 7 shows pseudocode 700 for a camera placement algorithm (Algorithm 2). Particularly, using the camera placement algorithm, the processor 312 and/or the processor 332 determines a camera pose (position and orientation) that defines a perspective from which the animations are displayed on the display screen 338. The camera placement algorithm provides two different views for displaying animations: a part view and an assembly view.

To determine a camera placement for the part view, the processor 312 and/or the processor 332 computes, for each part pᵢ, a camera position c using its path Pⁱ. A ground-plane normal \hat{n} to the motion vector is calculated at the midpoint mⁱ of the path. The camera is placed along this normal at a distance proportional to the part's motion length and elevated to half that distance to create a focused, top-down view:

c=mⁱ+Lᵢ\hat{n}+0.5Lᵢ·U_{P}

where Lᵢ is the path length. If either the assembled state

$${s}_{0}^{i}$$

or disassembled state

$${s}_{n}^{i}$$

is not visible from this position (checked by a raycast), the system samples alternative directions \hat{d} within the plane orthogonal to the motion. This loop continues until a position is found from which both

$${s}_{0}^{i} and {s}_{n}^{i}$$

are visible. If visibility still fails, the system flips to the opposite −\hat{n} as a fallback. This ensures a focused, unobstructed view of each part's movement during playback.

To determine a camera placement for the assembly view, the processor 312 and/or the processor 332 samples the camera along a circular trajectory of radius 1.3R around the assembly center C, elevated by 0.5R, where R is the convex hull radius of the assembly. For each candidate position c, raycasts are tested to both

$${s}_{0}^{i} and {s}_{n}^{i} .$$

If a position provides visibility of both states, it is chosen. Otherwise, a fallback selects a position where at least the assembled state

$${s}_{0}^{i}$$

is visible. II no such position is found, the orbit radius is enlarged and resampled. This guarantees at least one informative viewpoint for every part.

In addition to these automated modes, the mechanical assembly guidance system 300 also supports manual camera control using standard keyboard and mouse inputs, allowing users to explore the scene freely between animations or switch perspectives during playback if desired. Users can switch between any of these camera modes during an animation.

Thus, it should be appreciated that the animation engine 150 ensures a cohesive and realistic experience by synchronizing narration and animations while adhering to assembly dependencies. The integrated camera system further enhances the experience by providing adaptive and contextually relevant viewpoints for each part animation, completing the interactive system's goal of delivering adaptive, intuitive, and user-centered mechanical assembly guidance.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general-purpose or special-purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data that cause a general-purpose computer, special-purpose computer, or special-purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A method for providing mechanical assembly guidance to a user, the method comprising:
receiving a natural language query from the user, the natural language query including a question relating to at least one part from a plurality of parts of an apparatus that is to be assembled from the plurality of parts;
determining a sequence of assembly steps for assembling the apparatus based on the natural language query, the sequence of assembly steps being adapted to a current state of assembly of the apparatus;
determining, for each respective assembly step in the sequence of assembly steps, (i) respective natural language text instructions for the user to perform the respective assembly step and (ii) a respective animation that demonstrates the respective assembly step; and
outputting, with at least one output device, the respective natural language text instructions and the respective animation for at least one assembly step of the sequence of assembly steps.

2. The method according to claim 1 further comprising:
classifying a query type of the natural language query based on at least one of (i) a number of parts in the plurality of parts to which the question relates and (ii) whether the question relates to assembling the apparatus.

3. The method according to claim 2, the classifying the query type of the natural language query further comprising:
classifying the natural language query as a first query type in response to the question not being related to assembling the apparatus;
classifying the natural language query as a second query type in response to the question relating to assembling a single part in the plurality of parts;
classifying the natural language query as a third query type in response to the question relating to assembling multiple parts in the plurality of parts; and
classifying the natural language query as a fourth query type in response to the question relating to assembling all of the plurality of parts.

4. The method according to claim 3, wherein the sequence of assembly steps and the respective animations are only determined in response to the query being classified as one of the first query type, the second query type, and the third query type.

5. The method according to claim 2, the classifying the query type of the natural language query further comprising:
receiving an image of the apparatus from a point of view of the user; and
classifying the query type the natural language query based on the image and based on the at least one of (i) the number of parts in the plurality of parts to which the question relates and (ii) whether the question relates to assembling the apparatus.

6. The method according to claim 2, the classifying the natural language query further comprising:
classifying the query type of the natural language query using a large language model.

7. The method according to claim 2, the determining the sequence of assembly steps further comprising:
identifying a subset of parts in the plurality of parts that have not yet been assembled in the apparatus; and
determining the sequence of assembly steps based on (i) the query type and (ii) assembly dependencies of the plurality of parts, the assembly dependencies indicating, for each respective part in the subset of parts, at least one of the plurality of parts that must be assembled in the apparatus prior to assembling the respective part in the apparatus.

8. The method according to claim 7, further comprising:
determining the assembly dependencies of the plurality of parts including, for each respective part in the plurality of parts, respective assembly dependencies of the respective part.

9. The method according to claim 8, the determining the respective assembly dependencies for each respective part in the plurality of parts further comprising:
determining, for each respective part in the plurality of parts, a respective motion path for assembling the respective part in the apparatus; and
determining the respective assembly dependencies for each respective part in the plurality of parts, based on the respective motion path for each respective part in the plurality of parts.

10. The method according to claim 9, the determining the respective assembly dependencies of the respective part further comprising:
checking if the respective part would collide with other parts in the plurality parts while assembling the respective part in the apparatus.

11. The method according to claim 8, the determining the respective assembly dependencies for each respective part in the plurality of parts further comprising:
defining a dependency graph based on the respective assembly dependencies for each respective part in the plurality of parts.

12. The method according to claim 1 further comprising:
identifying a subset of parts in the plurality of parts that have not yet been assembled in the apparatus; and
determining, for each respective assembly step in the sequence of assembly steps, the respective natural language text instructions based on (i) the subset of parts and (ii) the natural language query.

13. The method according to claim 12 further comprising:
receiving semantic names for the subset of parts; and
determining, for each respective assembly step in the sequence of assembly steps, the respective natural language text instructions to incorporate the semantic names for the subset of parts.

14. The method according to claim 13 further comprising:
receiving images of each part in the plurality of parts and of the apparatus in a fully assembled state; and
determining the semantic names for the plurality of parts based on the images, the semantic names for the plurality of parts including the semantic names for the subset of parts.

15. The method according to claim 14, the determining the semantic names for the plurality of parts further comprising:
the determining the semantic names for the plurality of parts based on the images using a vision language model.

16. The method according to claim 1 further comprising:
receiving user profile information; and
determining the respective natural language text instructions, for each respective assembly step in the sequence of assembly steps, based on (i) the user profile information and (ii) the natural language query.

17. The method according to claim 1 further comprising:
receiving an image of the apparatus from a point of view of the user; and
determining the respective natural language text instructions, for each respective assembly step in the sequence of assembly steps, based on (i) the image and (ii) the natural language query.

18. The method according to claim 1, the determining the respective natural language text instructions for each respective assembly step in the sequence of assembly steps further comprising:
determining the respective natural language text instructions using a large language model.

19. The method according to claim 1, the determining the respective animation for each respective assembly step in the sequence of assembly steps further comprising:
determining, for a respective part in the plurality of parts in the apparatus that is involved in the respective assembly step, a respective motion path for assembling the respective part in the apparatus; and
generating the respective animation by animating the respective part to move along the respective motion path.

20. The method according to claim 1, the outputting further comprising:
converting the respective natural language text instructions for each respective assembly step in the sequence of assembly steps to respective spoken audio instructions using a text-to-speech algorithm;
determining a respective duration of the respective spoken audio instructions for each respective assembly step in the sequence of assembly steps; and
outputting the respective spoken audio instructions and the respective animation for at least one assembly step of the sequence of assembly steps in a synchronized manner, depending on the respective duration of the respective spoken audio instructions for each of the at least one assembly step in the sequence of assembly steps.
